(19) United States
(12) Patent Application Publication
(10) Pub. No.: US 2026/0217902 A1
(43) Pub. Date: Jul. 30, 2026

(54) STABILIZED AQUEOUS ANODE COMPOSITION

(71) Applicant: COATEX, Genay (FR)

(72) Inventors: Catherine CORFIAS ZUCCALLI, Villeurbanne (FR); Haifeng LIU, Suzhou (CN); Guillaume MICHAUD, Lyon (FR); Gael ROBIN, Sathonya-Camp (FR); Jean Marc SUAU, Lucenay (FR)

(73) Assignee: COATEX, Genay (FR)

(21) Appl. No.: 19/148,408

(22) PCT Filed: Feb. 6, 2024
(86) PCT No.: PCT/FR2024/000015

§ 371 Date: Jul. 16, 2025

(30) Foreign Application Priority Data
Feb. 7, 2023 (CN) 202310125053.5
Feb. 23, 2023 (FR) FR2301657

(51) Int. Cl. C08G 18/76; H01M 4/02; H01M 4/04; H01M 4/62

(52) U.S. Cl. CPC C08G 18/7621; H01M 4/0402; H01M 4/0435; H01M 4/624; H01M 2004/027

(57) ABSTRACT

An aqueous anode composition stabilized by a polyurethane rheological agent made of carbon graphite or metallic particles or fibers and a binding agent. A method for producing an anode using the aqueous composition, and to the resulting anode.

The invention relates to an aqueous anode composition stabilised with a polyurethane rheological agent that also comprises a binding agent and metal or carbon graphite particles or fibres. The invention also relates to a method for producing an anode using this aqueous composition and the anode obtained.

There are known anode compositions that generally comprise carbon or a metal in the form of particles combined with a binding composition. This binding composition must be able to effectively bind the carbon or the metal to a substrate to form an anode. The most common binding compositions comprise a styrene-butadiene polymer and make it possible to attach active particles to a metal substrate. Binding properties, mechanical strength or electrochemical resistance are particularly important when producing and using an anode. Indeed, the quality of the anode composition coating applied to the metal substrate is essential to the optimum efficacy of the anode as well as to its maximum durability. The thixotropic behaviour or rheological behaviour over time of an aqueous anode composition must therefore be controlled to the extent possible.

It is also advantageous to have versatile anode compositions that retain their rheological properties when used under different conditions.

Easy, uniform application of anode compositions is necessary in order to obtain a uniform coat and to limit or avoid flaws on the surface of the anode, resulting in a uniform and particularly effective conductive coat. Surface levelling, restructuring and flow behaviour of an aqueous anode composition must be well controlled.

It is therefore essential to be able to provide anode compositions with a very well controlled rheology. Indeed, in addition to application issues, excessive viscosity generally leads to numerous flaws in the coat deposited on the surface of the anode. Insufficient viscosity results in the same types of problem and also leads to uncontrolled flows of the anode composition during its application.

Anode compositions must also be stable and homogenous during their preparation, storage or application. Settling, cluster or aggregate formation and ingredient separation must therefore be limited or avoided.

These anode compositions frequently comprise silicon in order to increase the capacity of the prepared anodes. During the charging-discharging cycles of the batteries containing these anodes, it is usual to observe a strain that can lead to irreversible alteration of the anode, particularly as a result of the increase in the volume of the silicon. Strain tolerance is therefore also a desirable property.

The compatibility of the different ingredients of the anode compositions is also an important factor when preparing anode compositions as well as when preparing anodes using these compositions.

Document JP 2015220170 relates to the use, when preparing an anode for a battery, of a polymer binder made of thermoplastic resin prepared using poly(tetramethylene glycol), diethylene glycol, IPDI and N,N′-dimethylformamide. Document WO 2021014054 describes an aqueous thickening composition made of an osidic compound and of a polyurethane polymer.

The anode compositions in the prior art are not always satisfactory. There is thus a need for anode compositions that provide solutions to all or part of the problems of the anode compositions in the prior art.

Thus, the invention provides an aqueous anode composition T comprising:
at least one rheological agent R comprising at least one water-soluble, non-ionic urethane polymer P prepared by polymerisation reaction:
   a) of at least one isocyanate compound (a) independently chosen among a diisocyanate compound (a1), a polyisocyanate compound (a2) and combinations thereof;
   b) of at least one compound (b) of formula I:

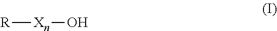

wherein:
   R independently represents a group chosen among a straight C₄-C₄₀-alkyl group, a branched C₄-C₄₀-alkyl group, a C₅-C₄₀-cycloalkyl group, a straight C₄-C₄₀-alkenyl group, a branched C₄-C₄₀-alkenyl group, a C₅-C₄₀-cycloalkenyl group, a C₅-C₄₀-aryl group and combinations thereof,
   X independently represents an alkoxylated group chosen among oxyethylene, oxypropylene, oxybutylene and combinations thereof,
   n represents 0 or a number ranging from 1 to 500;
   c) of at least one polyhydroxylated and polyalkoxylated compound (c);
at least one material E chosen among metal fibres, metal particles, carbon graphite fibres, carbon graphite particles, silicon particles and combinations thereof; and
at least one binding agent L of the material E chosen among a polymer L1 in the form of a water-insoluble latex, a water-soluble polymer L2 and combinations thereof.

Essentially according to the invention, the anode composition comprises at least one rheological agent R comprising a urethane polymer P prepared using an isocyanate compound (a) chosen among a diisocyanate compound (a1), a polyisocyanate compound (a2) and combinations thereof.

Preferably for the composition T according to the invention, the diisocyanate compound (a1) is chosen among:
the symmetric aromatic diisocyanate compounds, preferably 2,2′-methylene diphenyl diisocyanate (2,2′-MDI); 4,4′-methylene diphenyl diisocyanate (4,4′-MDI); 4,4′-dibenzyl diisocyanate (4,4′-DBDI); 2,6-toluene diisocyanate (2,6-TDI); m-xylylene diisocyanate (m-XDI);
the symmetric alicyclic diisocyanate compounds, preferably methylene bis(4-cyclohexylisocyanate) (H₁₂MDI);
the symmetric aliphatic diisocyanate compounds, preferably hexamethylene diisocyanate (HDI), pentamethylene diisocyanate (PDI);
the asymmetric aromatic diisocyanate compounds, preferably 2,4′-diphenylmethylene diisocyanate (2,4′-MDI), 2,4′-dibenzyl diisocyanate (2,4′-DBDI), 2,4-toluene diisocyanate (2,4-TDI);
the asymmetric alicyclic diisocyanate compounds, preferably isophorone diisocyanate (IPDI).

Preferably according to the invention, the compound (a1) is chosen among IPDI, HDI, H₁₂MDI and combinations thereof.

Also preferably for the composition T according to the invention, the polyisocyanate compound (a2) strictly comprises more than 2 isocyanate groups or more than 2.2 isocyanate groups or even more than 2.5 isocyanate groups. More preferably, the polyisocyanate compound (a2) comprises more than 2.6 isocyanate groups or more than 2.7 isocyanate groups or more than 3 isocyanate groups. Much more preferably, the polyisocyanate compound (a2) comprises from 2.2 to 6 isocyanate groups, from 2.2 to 4 isocyanate groups, from 2.2 to 3.5 isocyanate groups, from 2.5 to 6 isocyanate groups, from 2.2 to 5 isocyanate groups, from 2.5 to 4 isocyanate groups, from 2.5 to 3.5 isocyanate groups, in particular from 2.6 to 3.3 isocyanate groups.

More preferably, the polyisocyanate compound (a2) is chosen among:
triphenylmethane-4,4′,4″-triisocyanate or 1,1′,1″-methylidynetris (4-isocyanatobenzene);
an isocyanurate compound, in particular an isocyanurate compound of a compound chosen among:
   the symmetric aromatic diisocyanate compounds, preferably 2,2′-methylene diphenyl diisocyanate (2,2′-MDI); 4,4′-methylene diphenyl diisocyanate (4,4′-MDI); 4,4′-dibenzyl diisocyanate (4,4′-DBDI); 2,6-toluene diisocyanate (2,6-TDI); m-xylylene diisocyanate (m-XDI);
   the symmetric alicyclic diisocyanate compounds, preferably methylene bis(4-cyclohexylisocyanate) (H₁₂MDI);
   the symmetric aliphatic diisocyanate compounds, preferably hexamethylene diisocyanate (HDI), pentamethylene diisocyanate (PDI);
   the asymmetric aromatic diisocyanate compounds, preferably 2,4′-diphenylmethylene diisocyanate (2,4′-MDI), 2,4′-dibenzyl diisocyanate (2,4′-DBDI), 2,4-toluene diisocyanate (2,4-TDI);
a biuret trimer compound, in particular a biuret trimer compound of a compound chosen among:
   the symmetric aromatic diisocyanate compounds, preferably 2,2′-methylene diphenyl diisocyanate (2,2′-MDI); 4,4′-methylene diphenyl diisocyanate (4,4′-MDI); 4,4′-dibenzyl diisocyanate (4,4′-DBDI); 2,6-toluene diisocyanate (2,6-TDI); m-xylylene diisocyanate (m-XDI);
   the symmetric alicyclic diisocyanate compounds, preferably methylene bis(4-cyclohexylisocyanate) (H₁₂MDI);
   the symmetric aliphatic diisocyanate compounds, preferably hexamethylene diisocyanate (HDI), pentamethylene diisocyanate (PDI);
   the asymmetric aromatic diisocyanate compounds, preferably 2,4′-diphenylmethylene diisocyanate (2,4′-MDI), 2,4′-dibenzyl diisocyanate (2,4′-DBDI), 2,4-toluene diisocyanate (2,4-TDI);
   the asymmetric alicyclic diisocyanate compounds, preferably isophorone diisocyanate (IPDI).

More preferably according to the invention, the compound (a2) is chosen among triphenylmethane-4,4′,4″-triisocyanate, 1,1′,1″-methylidynetris (4-isocyanatobenzene), an HDI isocyanurate, an IPDI isocyanurate, a PDI isocyanurate, an HDI biuret trimer, an IPDI biuret trimer, a PDI biuret trimer.

Preferably for the composition T according to the invention, the compound (b) is a compound of formula I wherein:
R independently represents a group chosen among a straight C₆-C₃₂-alkyl group, a branched C₆C₃₂-alkyl group, a C₆-C₃₂-cycloalkyl group, a straight C₆-C₃₂-alkenyl group, a branched C₆-C₃₂-alkenyl group, a C₆-C₃₂-cycloalkenyl group, a C₆-C₃₆-aryl group and combinations thereof, preferably
R independently represents a group chosen among a straight C₆-C₂₄-alkyl group, a branched C₆-C₂₄-alkyl group, a C₆-C₂₄-cycloalkyl group, a straight C₆-C₂₄-alkenyl group, a branched C₆-C₂₄-alkenyl group, a C₆-C₂₄-cycloalkenyl group, a C₆-C₃₂-aryl group and combinations thereof; or
X independently represents an alkoxylated group chosen among an ethoxylated group, a propoxylated group, a butoxylated group and combinations thereof; preferably X represents an ethoxylated group or a combination of ethoxylated groups and propoxylated groups, more preferentially X represents an ethoxylated group; or
n represents 0 or a number ranging from 1 to 300, preferably from 1 to 150 or from 1 to 100, more preferentially from 1 to 50 or from 1 to 25.

More preferably for the composition T according to the invention, the compound (b) is a compound of formula I wherein:
R independently represents a group chosen among a straight C₆-C₃₂-alkyl group, a branched C₆C₃₂-alkyl group, a C₆-C₃₂-cycloalkyl group, a straight C₆-C₃₂-alkenyl group, a branched C₆-C₃₂-alkenyl group, a C₆-C₃₂-cycloalkenyl group, a C₆-C₃₆-aryl group and combinations thereof, preferably
R independently represents a group chosen among a straight C₆-C₂₄-alkyl group, a branched C₆-C₂₄-alkyl group, a C₆-C₂₄-cycloalkyl group, a straight C₆-C₂₄-alkenyl group, a branched C₆-C₂₄-alkenyl group, a C₆-C₂₄-cycloalkenyl group, a C₆-C₃₂-aryl group and combinations thereof; and
X independently represents an alkoxylated group chosen among an ethoxylated group, a propoxylated group, a butoxylated group and combinations thereof; preferably X represents an ethoxylated group or a combination of ethoxylated groups and propoxylated groups, more preferentially X represents an ethoxylated group; and
n represents 0 or a number ranging from 1 to 300, preferably from 1 to 150 or from 1 to 100, more preferentially from 1 to 50 or from 1 to 25.

According to the invention, the group R can also represent a radical of formula:

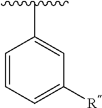

wherein R″ represents a hydrocarbon group of formula C₁₅H₃₁₋ₓ wherein x represents 0, 2, 4, 6; which can thus comprise 0, 1, 2 or 3 ethylenic unsaturations (double bond). Such a radical is advantageously a cardanyl group derived from cardanol. According to the invention, the group R can also represent a pentastyrylcumylphenyl group, a tristyrylphenyl group (TSP) of formula:

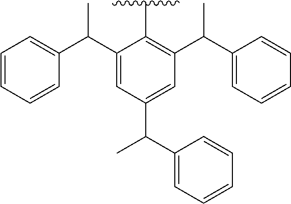 [SMILES: *c1c(C(C)c2ccccc2)cc(C(C)c2ccccc2)cc1C(C)c1ccccc1]

or a distyrylphenyl group (DSP) of formula:

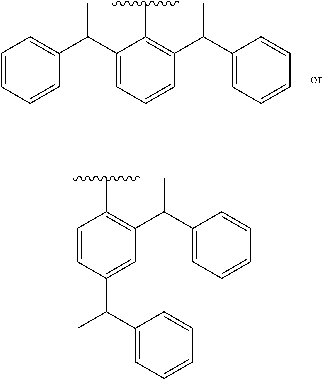 [SMILES: *c1c(C(C)c2ccccc2)cccc1C(C)c1ccccc1 ; *c1ccc(C(C)c2ccccc2)cc1C(C)c1ccccc1]

According to the invention, the urethane polymer P is prepared using at least one polyhydroxylated and polyalkoxylated compound (c). Preferably for the composition T according to the invention, the compound (c) can be a compound (c1) of formula II:

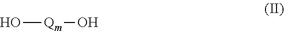

wherein:
   Q independently represents an oxyalkylene residue;
   m independently represents a number ranging from 30 to 1,000.

More preferably for the composition T according to the invention, the compound (c) can be a compound (c1) of formula II wherein:
Q independently represents an oxyethylene residue; or
m independently represents a number ranging from 50 to 600, preferably from 100 to 600.

More preferably for the composition T according to the invention, the compound (c) can be a compound (c1) of formula II wherein Q independently represents an oxyethylene residue and m independently represents a number ranging from 50 to 600, preferably from 100 to 600.

Also preferably for the composition T according to the invention, the compound (c) can be a compound (c1) of formula II combined with a non-alkoxylated compound (c2) comprising at least three hydroxyl groups. Preferably for the composition T according to the invention, the compound (c2) comprises three hydroxyl groups. More preferably, it is chosen among glycerol, pentaerythritol and combinations thereof.

Also preferably for the composition T according to the invention, the compound (c) can be a polyalkoxylated compound (c3) comprising at least three hydroxyl groups. The polyalkoxylated compound (c3) is different from the compound (c2). More preferably, the polyalkoxylated compound (c3) comprises three hydroxyl groups. Much more preferably, the compound (c3) is chosen among polyethoxylated glycerol, polyethoxylated pentaerythritol and combinations thereof.

According to the invention, the compound (c) can be used in the form of one or more combinations of compounds (c1), (c2) and (c3).

Essentially according to the invention, the polyhydroxylated compound (c) is a polyalkoxylated compound. Preferably for the composition T according to the invention, the compound (c) comprises from 10 to 500 alkoxylations, preferably from 20 to 400 alkoxylations or from 10 to 300 alkoxylations. More preferentially, the compound (c) comprises from 20 to 250 alkoxylations.

Also preferably, the compound (c) is polyethoxylated or is polyethoxylated-polypropoxylated or is polyethoxylated-polybutoxylated. More preferably, the compound (c) is polyethoxylated.

According to the invention, the compound (c) generally comprises from 10 to 500 ethoxylations, preferably from 20 to 400 ethoxylations or from 10 to 300 ethoxylations. More preferentially, the compound (c) comprises from 20 to 250 ethoxylations.

The molar mass of the compound (c) can vary quite widely, in particular depending on the number of alkoxylations that the compound (c) comprises. Preferably, the compound (c), (c1) or (c3) independently has a molecular mass by weight (Mw) measured by SEC ranging from 1,500 g/mol to 40,000 g/mol. More preferably, their molecular mass by weight ranges from 2,000 g/mol to 25,000 g/mol, more preferentially from 2,000 g/mol to 20,000 g/mol or from 2,000 g/mol to 15,000 g/mol or from 2,000 g/mol to 12,000 g/mol. Much more preferentially, their molecular mass by weight ranges from 4,000 g/mol to 20,000 g/mol or from 4,000 g/mol to 15,000 g/mol or from 4,000 g/mol to 12,000 g/mol.

According to the invention, the molecular weight or mass is determined by Size Exclusion Chromatography (SEC). A test portion of the compound solution corresponding to 90 mg of dry solids content is introduced into a 10 ml bottle. Mobile phase is added, together with 0.04% of dimethylformamide (DMF), until a total mass of 10 g is reached. The composition of this mobile phase is as follows: NaHCO₃:0.05 mol/L, NaNO₃: 0.1 mol/L, triethanolamine: 0.02 mol/L, NaN₃ 0.03% by mass. The SEC chain is composed of a “Waters” 510 isocratic pump with a flow rate set to 0.8 mL/min of a “Waters” 717+ sample changer, of an oven containing a “Waters” Ultrahydrogel Column Guard precolumn 6 cm long and 40 mm in inner diameter, followed by a “Waters” Ultrahydrogel linear column 30 cm long and 7.8 mm in inner diameter. Detection is provided by means of a “Waters” 410 RI differential refractometer. The oven is brought to a temperature of 60° C. and the refractometer is brought to a temperature of 45° C. The SEC instrument is calibrated with a series of polyacrylate sodium standards supplied by Polymer Standards Service with a molecular weight at the top of the peak comprised between 900 g/mol and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using “PSS WinGPC Scientific” software v 4.02. The chromatogram obtained is incorporated into the area corresponding to molecular weights of more than 250 g/mol. When preparing the polymer P, the amounts of the various compounds used in the polymerisation reaction can vary quite widely. Preferably for the composition T according to the invention, the polymerisation reaction uses from 20 mol % to 74.9 mol % of compound (a) or from 25 mol % to 79.9 mol % of compound (b) or from 0.1 mol % to 55 mol % of compound (c) relative to the total molar amount of compounds (a), (b) and (c). More preferably, the polymerisation reaction uses from 25 mol % to 60 mol % of compound (a) or from 35 mol % to 70 mol % of compound (b) or from 5 mol % to 40 mol % of compound (c) relative to the total molar amount of compounds (a), (b) and (c).

Also preferably, the polymerisation reaction uses:
from 20 mol % to 74.9 mol %, preferably from 25 mol % to 60 mol %, of compound (a),
from 25 mol % to 79.9 mol %, preferably from 35 mol % to 70 mol %, of compound (b), and
from 0.1 mol % to 55 mol %, preferably from 5 mol % to 40 mol %, of compound (c),
relative to the total molar amount of compounds (a), (b) and (c).

The molar mass of the polymer P can vary quite widely, in particular depending on the number of alkoxylations of the compounds (b) and (c). Preferably, the polymer P has a molar mass (Mw) measured by SEC ranging from 4,000 g/mol to 150,000 g/mol; preferentially from 6,000 g/mol to 100,000 g/mol; more preferentially from 10,000 g/mol to 80,000 g/mol.

Essentially when preparing the polymer P, the polymerisation reaction uses the compounds (a), (b) and (c). Other monomers can also be used.

Preferably for the composition T according to the invention, the polymerisation reaction can also use at least one additional cross-linking compound (d), preferably a compound (d) comprising at least 3 functional groups chosen among OH, SH, primary amine, secondary amine and combinations thereof. More preferentially, the compound (d) is chosen among diethanolamine, triethanolamine, trimethylolpropane, glycerol, pentaerythritol, and combinations thereof.

Preferably, the compound (d) is used in an amount of less than 5 mol %, preferably from 0.01 mol % to 5 mol %, in particular from 0.1 mol % to 5 mol % of compound (d), relative to the total molar amount of monomers.

According to the invention, the rheological agent R comprises at least one urethane polymer P alone or combined with one or more other ingredients. The agent R can comprise a carrier, in particular a liquid carrier that can be chosen among water, polar organic solvents and combinations thereof. These solvents can be chosen among glycol, butyl glycol, butyldiglycol, monopropylene glycol, ethylene glycol, methyl carbonate, ethyl carbonate, propyl carbonate, esters, ketones, ethylene diglycol, “Dowanol” products with CAS number 34590-94-8, “Texanol” products with CAS number 25265-77-4 and combinations thereof. Preferably, the agent R comprises water in combination with the polymer P. The agent R can also comprise at least one other ingredient chosen among an amphiphilic compound, in particular a surfactant compound, preferably a hydroxylated surfactant compound, for example alkyl-polyalkylene glycol, in particular alkyl-polyethylene glycol and alkyl-polypropylene glycol; a polysaccharide derivative, for example cyclodextrin, cyclodextrin derivative, polyethers, alkyl-glucosides; a hydrotropic compound, an anti-foaming agent, a biocide and combinations thereof. Preferably according to the invention, the anti-foaming agent is chosen among silica, surfactant compounds, silicone derivatives and combinations thereof. In addition to the rheological agent R, the aqueous anode composition T according to the invention comprises at least one material E. Preferably for the composition T according to the invention, the material E is chosen among silicon, carbon graphite or graphitic carbon, hexagonal carbon, rhombohedral carbon and combinations thereof, optionally doped with at least one element, preferably chosen among lithium, silicon, germanium and combinations thereof.

The preferred material E is chosen among carbon graphite, silicon and combinations thereof.

Also preferably for the composition T according to the invention, the material E is in the form of particles, preferably particles with a volume-average size, measured by dynamic light scattering (DLS), of less than 200 μm, preferably less than 150 μm or less than 100 μm, or which ranges from 50 μm to 200 μm. The volume-average size is generally measured by dynamic light scattering.

In addition to the material E and the rheological agent R, the aqueous anode composition T according to the invention comprises at least one binding agent L of the material E, which can be a polymer L1 in the form of a water-insoluble latex or a water-soluble polymer L2.

Preferably for the composition T according to the invention, the polymer L1 is chosen among a styrene-butadiene rubber (SBR) polymer, phenyl-propane latex, ethylene/ethylene-acetate (EVA) copolymer, acrylic latex, methacrylic latex, acrylonitrile latex, polymethyl-methacrylate, water-insoluble ASE polymer latex, water-insoluble HASE polymer latex and combinations thereof.

Preferentially for the composition T according to the invention, the polymer L1 is a styrene-butadiene polymer.

Preferentially for the composition T according to the invention, the water-soluble polymer L2 is an acrylic latex. Also preferably for the composition T according to the invention, the water-soluble polymer L2 is independently chosen among a water-soluble ASE (alkali-swellable emulsion) polymer, a water-soluble HASE (hydrophobically-modified alkali-swellable emulsion) polymer, a water-soluble acrylic polymer, polyvinyl alcohol (PVA), poly(ethylene oxide) (PEO), carboxymethyl cellulose (CMC), sodium polyacrylate, modified polyacrylic acid, acrylamide homopolymer, acrylamide copolymer and combinations thereof. More preferably, the water-soluble polymer L2 is prepared by at least one emulsion polymerisation reaction with a water-soluble anionic monomer.

Preferentially for the composition T according to the invention, the polymer L2 is chosen among a water-soluble ASE polymer, sodium polyacrylate, modified polyacrylic acid, acrylamide copolymer and combinations thereof.

According to the invention, the polymer L2 is water-soluble, preferably water-soluble at a pH greater than or equal to 6 or greater than or equal to 7.

According to the invention, the water-soluble polymer L2 can be prepared in the presence of at least one initiator compound, by a polymerisation reaction of at least one anionic monomer M1 chosen among acrylic acid, methacrylic acid, an acrylic acid oligomer, an acrylic acid salt, a methacrylic acid salt and combinations thereof, and optionally of at least one monomer different from the monomer M1. Preferably, the other monomer different from the monomer M1 is independently chosen among an anionic monomer M2, an organosulphur monomer M3, a non-ionic monomer M4, a cross-linking monomer M5 and combinations thereof.

Preferably, the anionic monomer M2, different from the anionic monomer M1, is chosen among maleic acid, a maleic acid salt, itaconic acid, an itaconic acid salt, crotonic acid, a crotonic acid salt and combinations thereof.

Also preferably, the organosulphur monomer M3 is chosen among a sulphonated monomer M3a, a sulphated monomer M3b, and combinations thereof. More preferentially, the organosulphur monomer M3 is chosen among 2-acrylamido-2-methylpropane sulphonic acid (AMPS), allyl sulphonic acid, alkylene sulphonates, alkylenearyl sulphonates, in particular styrene sulphonate, vinyl sulphonate, methallyl sulphonate, allyl sulphonate, methallyl sulphate, allyl sulphate, 2-sulphoethyl methacrylate, 3-allyloxy-2-hydroxy-1-propanesulphonic acid, 3-sulphopropyl methacrylate, their salts and combinations thereof.

Also preferably, the non-ionic monomer M4 is chosen among vinyl acetate, a C₁-C₈ ester from a compound derived from an acid chosen among acrylic acid, methacrylic acid, maleic acid, itaconic acid and crotonic acid (for example ethyl methacrylate, methyl methacrylate, butyl methacrylate, ethyl acrylate, methyl acrylate, butyl acrylate), hydroxyethyl methacrylate, hydroxyethyl acrylate, hydroxypropyl methacrylate, hydroxypropyl acrylate, a nitrogen-containing monomer (for example acrylonitrile, methacrylamide, acrylamide, vinyl lactam, N-methylol acrylamide), styrene and combinations thereof.

Also preferably, the monomer M5 comprises at least 2 polymerisable ethylenic groups. More preferentially, the cross-linking monomer M5 is chosen among the polyvinyl aromatic monomers (for example divinyl benzene and diallyl phthalate); polyalkenyl ethers (triallyl pentaerythritol, diallyl pentaerythritol, diallyl sucrose, octa allyl sucrose, trimethylolpropane diallyl ether); polyunsaturated esters of polyalcohols or polyunsaturated esters of polyacids (for example trimethylolpropane tri(meth)acrylate, trimethylolpropane, polyethylene glycol di(meth)acrylates); diacrylic esters, dimethacrylic esters derived from polyols chosen in particular among pentaerythritol, sorbitol, sucrose; divinyl naphthalene, trivinyl benzene, 1,2,4-trivinylcyclohexane, triallyl pentaerythritol, diallyl pentaerythritol, diallyl sucrose, trimethylolpropane diallyl ether, 1,6-hexanediol di(meth)acrylate, allyl(meth)acrylate, diallyl itaconate, diallyl fumarate, diallyl maleate, butanediol dimethacrylate, ethylene di(meth)acrylate, poly(ethylene glycol) di(meth)acrylate, trimethylolpropane tri(meth)acrylate, methylenebis(meth)acrylamide, triallylcyanurates, diallyl phthalate, divinylbenzene; diallyl phthalate (DAP); ethylene glycol dimethacrylate (EGDMA); methylene bis acrylamide (MBA); divinylbenzene (DVB); bicyclopentenyloxyethyl-methacrylate (FRA); trimethylol propane triallyl ether (APE) and combinations thereof.

Preferably according to the invention, the polymer L2 is prepared using:
from 2% by weight to 100% by weight, preferably from 5% by weight to 98% by weight, of at least one monomer M1, and
from 0 to 98% by weight, preferably from 2% by weight to 95% by weight, of at least one other monomer, different from monomer M1, preferably of at least one other monomer chosen among monomer M2, monomer M3, monomer M4, monomer M5 and combinations thereof.

Also preferably, the water-soluble polymer L2 has a weight-average molecular mass Mw (measured by SEC) of less than 1,000,000 g/mol, preferably less than 800,000 g/mol or less than 500,000 g/mol, more preferentially less than 100,000 g/mol or less than 50,000 g/mol.

Also preferentially, the water-soluble polymer L2 has a weight-average molecular mass Mw (measured by SEC) greater than 2,000 g/mol or greater than 5,000 g/mol. More preferentially, the water-soluble polymer L2 has a weight-average molecular mass Mw (measured by SEC) ranging from 2,000 g/mol to 1,000,000 g/mol, preferably from 2,000 g/mol to 800,000 g/mol or from 2,000 g/mol to 500,000 g/mol, more preferentially from 2,000 g/mol to 100,000 g/mol or from 2,000 g/mol to 50,000 g/mol. Much more preferentially, the water-soluble polymer L2 has a weight-average molecular mass Mw (measured by SEC) ranging from 5,000 g/mol to 1,000,000 g/mol, preferably from 5,000 g/mol to 800,000 g/mol or from 5,000 g/mol to 500,000 g/mol, more preferentially from 5,000 g/mol to 100,000 g/mol or from 5,000 g/mol to 50,000 g/mol.

According to the invention, the polymer L2 can be prepared in a polar solvent, in particular a solvent chosen among water, alcohol, toluene, a ketone, a chlorinated solvent, an ester and combinations thereof.

Generally when preparing the polymer L2, the polymerisation reaction is carried out at a temperature above 30° C. and below 130° C., preferably below 100° C. or below 90° C. or even below 80° C. or below 75° C.

According to the invention, the polymer L2 is prepared in the presence of at least one initiator compound chosen among a peroxide (for example hydrogen peroxide), a hydroperoxide (for example tert-butyl hydroperoxide), a persulphate (for example sodium persulphate, ammonium persulphate, potassium persulphate), combinations thereof and associations thereof with a metal salt, preferably a metal salt chosen among an iron salt (for example Fe II or Fe III), a copper salt (for example Cu I or Cu II) and combinations thereof.

According to the invention, the polymer L2 can be prepared in the presence of a chain transfer agent, preferably in the presence of a compound chosen among isopropyl alcohol, mercaptan, dodecyl-mercaptan, phosphorous acid, phosphite, for example sodium phosphite, hypophosphorous acid, hypophosphite, for example sodium hypophosphite, bisulphite, for example sodium bisulphite, an alkyl iodide, an alkyl bromide.

The polymer L2 can be non-neutralised or can be partially or totally neutralised, preferably neutralised using a monovalent ion, a divalent ion or combinations thereof, more preferentially using at least one compound chosen among LiOH, NaOH, KOH, NH₄OH, Ca(OH)₂, Mg(OH)₂, MgO, CaO, ZnO and combinations thereof. The polymer L2 can also be partially or completely neutralised using an amine chosen among tertiary amine, secondary amine, primary amine and combinations thereof. The pH of the polymer L2 is generally less than 12 or less than 11 or ranges from 2 to 12 or from 5 to 11. Its pKa is generally less than 3.5 or ranges from 1.5 to 2.5.

Within the composition T according to the invention, the amounts of the ingredients can vary. Preferably according to the invention, the composition T comprises:
from 0.2% by dry weight to 5% by dry weight of rheological agent R,
from 85% by dry weight to 99.5% by dry weight of material E and
from 0.3% by dry weight to 10% by dry weight of binding agent, in particular binding agent L,
   relative to the total amount by dry weight of rheological agent R, of binding agent, in particular of binding agent L, and of material E.

The composition T according to the invention comprises at least one binding agent L. Preferably, the composition T according to the invention can comprise at least one other binding compound different from the agent L or it can comprise no other binding compound other than the binding agent L. Preferably when using another binding compound, different from the binding agent L, it is chosen among cellulose, in particular carboxymethyl-cellulose (CMC), hydroxy-cellulose (in particular hydroxymethyl cellulose or hydroxyethyl cellulose), alginate, poly(allylamine, HCl), pectin, amilopectin, guar gum and combinations thereof.

The composition T according to the invention can also comprise at least one other compound chosen among a (meth)acrylic comb polymer, polyethylene, a fluorinated binding compound, for example a compound chosen among polyvinylidene fluoride (PVDF), poly(vinyl-pyrrolidone), polytetrafluoroethylene (PTFE), chlorotrifluoroethylene (ECTFE), polyethylene tetrafluoroethylene (ETFE), fluorinated ethylene propylene (FEP), perfluoroalkoxy (PFA), polychlorotrifluoroethylene (PCTFE), fluoracrylates, fluorosilicones and combinations thereof.

The composition T according to the invention can also comprise at least one organic acid or one mineral acid, preferably an acid chosen among sulphuric acid, phosphoric acid, phosphorous acid, hypophosphorous acid, acetic acid, lactic acid and combinations thereof.

The composition T according to the invention can also comprise at least one dispersing agent of material E, preferably chosen among a (meth)acrylic acid homopolymer, a (meth)acrylic acid copolymer and at least one other monomer and combinations thereof; more preferentially a dispersing agent with a molecular mass by weight measured by SEC ranging from 3,000 g/mol to 2,000,000 g/mol, in particular ranging from 5,000 g/mol to 900,000 g/mol. According to the invention, the dispersing agent is advantageously used in an amount by dry weight ranging from 0.05% by weight to 5% by weight, preferably from 0.1% by weight to 2% by weight, relative to the total amount by dry weight of rheological agent R, of binding agent, in particular of binding agent L, of material E and of dispersing agent.

Particularly advantageously, the rheological agent R according to the invention makes it possible to control the viscosity of the composition T according to the invention.

Preferably, the composition T according to the invention has a viscosity, measured at 25° C. and at 0.01 s⁻¹ according to the method used in the examples, greater than 2 mPa·s, preferably greater than 5 mPa·s. Also preferably, the composition T according to the invention has a viscosity, measured at 25° C. and at 0.01 s⁻¹ according to the method used in the examples, of less than 50 mPa·s or less than 100 mPa·s.

Also preferably, the composition T according to the invention has a viscosity, measured at 25° C. and at 1,000 s⁻¹ according to the method used in the examples, greater than 0.1 mPa·s, preferably greater than 0.2 mPa·s. Also preferably, the composition T according to the invention has a viscosity, measured at 25° C. and at 1,000 s⁻¹ according to the method used in the examples, of less than 5 mPa·s or less than 1 mPa·s.

Also particularly advantageously, the rheological agent according to the invention makes it possible to control the viscoelasticity of the composition T according to the invention. According to the invention, the variation in the dephasing angle δ) (°, obtained by the ratio of the loss modulus G″ to the elastic modulus G′ (tan δ=G″/G′), is measured in relation to the variation in shear stress. The elastic modulus G′ and loss modulus G″ are quantified using viscoelasticity measurements at 1 Hz with a rheometer equipped with a plane-cone spindle (CP35) under imposed stress.

Preferably, the composition T according to the invention has a dephasing angle at 1 Hz, measured at 25° C. and at 0.01 Pa according to the method used in the examples, greater than 30°, preferably greater than 50°; or less than 90°. Also preferably, the composition T according to the invention has a dephasing angle at 1 Hz, measured at 25° C. and 100 Pa according to the method used in the examples, greater than 60°, preferably greater than 70° or less than 90°.

Preferably according to the invention, the composition T is not an emulsion.

The invention also relates to the preparation of the aqueous composition T according to the invention. Thus, the invention provides a method for preparing an aqueous composition T comprising:
the preparation of a binding agent L,
the preparation of a rheological agent R,
the addition of at least one material E chosen among metal fibres, metal particles, carbon graphite fibres, carbon graphite particles and combinations thereof, preferably the material E is chosen among silicon, carbon graphite or graphitic carbon, hexagonal carbon, rhombohedral carbon and combinations thereof, optionally doped with at least one element, preferably chosen among lithium, silicon, germanium and combinations thereof.

The aqueous composition T according to the invention can be an essential ingredient in the production of an anode. Thus, the invention provides a method for producing an anode comprising:
applying at least one composition T according to the invention to a substrate,
drying and then calendering the coated substrate.

Preferably according to the invention, the substrate is a metal substrate, preferably a metal substrate chosen among copper, titanium, silver, zinc, nickel and combinations thereof. More preferably according to the invention, the substrate is a copper substrate.

Preferably according to the invention, the manufacturing method according to the invention comprises applying the composition T at a pH of less than 7 or at a pH ranging from 4 to 6.5.

Preferably according to the invention, the composition T is applied to the substrate at a thickness, after drying and calendering, measured using a 1 μm to 1,000 μm coating thickness gauge, that is less than 500 μm, preferably less than 100 μm or less than 20 μm. Also preferably according to the invention, the composition T is applied to the substrate at a thickness, after drying and calendering, measured using a 1 μm to 1,000 μm coating thickness gauge, that is greater than 5 μm.

More preferably according to the invention, the composition T is applied to the substrate at a thickness, after drying and calendering, measured using a 1 μm to 1,000 μm coating thickness gauge, ranging from 5 μm to 500 μm, preferably from 5 μm to 100 μm or from 5 μm to 20 μm.

Particularly advantageously according to the invention, the composition T is uniformly applied to the substrate. Preferably, the composition Tis uniformly applied to the substrate according to the method used in the examples.

The invention also provides an anode produced according to the manufacturing method according to the invention.

According to the invention, the particular, advantageous or preferred characteristics of the composition T according to the invention define preparation methods, manufacturing methods and anodes which are also particular, advantageous or preferred.

The following examples illustrate the various aspects of the invention.

### EXAMPLES

### Preparation of Urethane Polymers P According to the Invention and of Rheological Agents R According to the Invention

### Copolymer P1 and Rheological Agent R1

In a 2 L glass reactor equipped with a mechanical stirring rod, a vacuum pump, and a nitrogen inlet and heated using a double jacket in which oil circulates, a compound (c) (polyethylene glycol—molecular mass 10,000 g/mol) (260.8 g) is introduced and heated to 95° C. under vacuum. Then, under stirring and in inert atmosphere, 0.17 g of a DBU catalyst (1,8-diazabicyclo[5.4.0]undec-7-ene) is added, then a compound (b) of formula I wherein n represents 4, X represents an ethoxylated group and R represents a cardanyl group (Surfaline CL4 by Arkema) (25 g) is added over 15 minutes. Then, a diisocyanate compound (a1) (isophorone diisocyanate, IPDI) (16.8 g) is introduced using a syringe and under stirring at 150 rpm. The reaction is continued at 100° C. for 1 hour.

The isocyanate level is then checked by back-assay to ensure that it is zero. 1 g is collected from the reaction medium to which an excess of dibutylamine (1 mol aqueous solution) is added, which reacts with any isocyanate groups present. Any unreacted dibutylamine is then measured using an aqueous solution of 1 N hydrochloric acid. The amount of isocyanate groups present in the reaction medium can then be deduced. If this amount is not zero, the reaction is continued for 15-minute periods until the reaction is completed. The resulting copolymer P1 is formulated with an ethoxylated alcohol-type surfactant compound (“Emulan” HE51 “Basf”) (202 g), 1,000 ppm of a biocide (“Biopol” SMV “Chemipol”), 1,000 ppm of an anti-foaming agent (“Tego” 1488 “Evonik”) and water (495 g). This results in an aqueous rheology control composition R1 made of 30% by mass of copolymer P1 according to the invention, of 20% by mass of surfactant compound and of 50% by mass of water.

### Copolymer P2 and Rheological Agent R2

In a 2 L glass reactor equipped with a mechanical stirring rod, a vacuum pump, and a nitrogen inlet and heated using a double jacket in which oil circulates, a compound (c) (polyethylene glycol—molecular mass 10,000 g/mol) (155.5 g) is introduced and heated to 95° C. under vacuum. Then, under stirring and in inert atmosphere, 0.33 g of a DBU catalyst is added to the medium, then a compound (b) of formula I wherein n represents 0 and R represents a straight C₁₂-alkyl group (“Nacol” 12-96 “Sasol”) (3.5 g), another compound (b) of formula I wherein n represents 0 and R represents a 4-dodecanyl-cyclohexyl group (“Marlipal” VS18 “Sasol”) (7.0 g) and a third compound (b) of formula I wherein n represents 0 and R represents an n-octanyl group (“Nacol” 8 “Sasol”) (0.65 g) are added simultaneously over 15 minutes. Then, a diisocyanate compound (a1) (IPDI) (11.0 g) is introduced using a syringe and under stirring at 150 rpm. The reaction is continued at 100° C. for 1 hour.

The isocyanate level is then checked by back-assay to ensure that it is zero. The resulting copolymer P2 is formulated with ethoxylated alcohol-type surfactant compounds (“Emulan” HE51 “Basf”) (48.3 g) and (“Simulsol” Ox1008 “Seppic”) (48.3 g), 1,000 ppm of a biocide (“Biopol” SMV “Chemipol”), 1,000 ppm of an anti-foaming agent (“Tego” 1488 “Evonik”) and water (725 g). This results in an aqueous rheology control composition R2 made of 17.5% by mass of copolymer P2 according to the invention, of 9.5% by mass of surfactant compounds and of 73% by mass of water.

### Copolymer P3 and Rheological Agent R3

In a 2 L glass reactor equipped with a mechanical stirring rod, a vacuum pump, and a nitrogen inlet and heated using a double jacket in which oil circulates, a compound (c) (polyethylene glycol—molecular mass 10,000 g/mol) (271 g) is introduced and heated to 95° C. under vacuum. Then, under stirring and in inert atmosphere, a compound (b) of formula I wherein n represents 0 and R represents a straight C₁₆-alkyl group (“Nacol” 16-95 “Sasol”) (16.2 g) is added over 15 minutes. Then, a diisocyanate compound (a1) (toluene diisocyanate, TDI) (11.6 g) is introduced using a syringe and under stirring at 150 rpm. The reaction is continued at 100° C. for 1 hour.

The isocyanate level is then checked by back-assay to ensure that it is zero. The resulting copolymer P3 is formulated with an ethoxylated alcohol-type surfactant compound (“Disponil” D8, “Cognis”) (198 g), 1,000 ppm of a biocide (“Biopol” SMV “Chemipol”), 1,000 ppm of an anti-foaming agent (“Tego” 1488 “Evonik”) and water (500 g). This results in an aqueous rheology control composition R3 made of 30% by mass of copolymer P3 according to the invention, of 20% by mass of surfactant compound and of 50% by mass of water.

### Copolymer P4 and Rheological Agent R4

In a 2 L glass reactor equipped with a mechanical stirring rod, a vacuum pump, and a nitrogen inlet and heated using a double jacket in which oil circulates, a compound (c) (polyethylene glycol—molecular mass 10,000 g/mol) (152.7 g) is introduced and heated to 95° C. under vacuum. Then, under stirring and in inert atmosphere, 0.2 g of a DBU catalyst is added to the medium, then a compound (b) which is a polybranched Guerbet alcohol obtained by dimerisation of branched and straight C₁₂ and C₁₃ alcohols (CAS No. 2041102-78-5—“Isofol” 2426S “Sasol”) (6.7 g), another compound (b) of formula I wherein n represents 3, X represents an ethoxylated group and R represents a tristyrylphenyl group (“Simulsol” TS 26 “Seppic”) (4.8 g) and a third compound (b) of formula I wherein n represents 0 and R represents a 2-butyl-1-octanol group (CAS No. 3913-02-8—“Isofol” 12 “Sasol”) (3.4 g) are added simultaneously over 15 minutes. Then, a diisocyanate compound (a1) (IPDI) (10.2 g) is introduced using a syringe and under stirring at 150 rpm. The reaction is continued at 100° C. for 1 hour.

The isocyanate level is then checked by back-assay to ensure that it is zero. The resulting copolymer P4 is formulated with ethoxylated alcohol-type surfactant compounds (“Emulan” HE51 “Basf”) (48.3 g) and (“Simulsol” Ox1008 “Seppic”) (48.3 g), 1,000 ppm of a biocide (“Biopol” SMV “Chemipol”), 1,000 ppm of an anti-foaming agent (“Tego” 1488 “Evonik”) and water (725 g). This results in an aqueous rheology control composition R4 according to the invention made of 17.5% by mass of copolymer P4 according to the invention, of 9.5% by mass of surfactant compounds and of 73% by mass of water.

### Copolymer P5 and Rheological Agent R5

In a 2 L glass reactor equipped with a mechanical stirring rod, a vacuum pump, and a nitrogen inlet and heated using a double jacket in which oil circulates, a compound (c) (polyethylene glycol—molecular mass 10,000 g/mol) (151.3 g) is introduced and heated to 95° C. under vacuum. Then, under stirring and in inert atmosphere, 0.01 g of a DBU catalyst is added, then a compound (b) of formula I wherein n represents 0 and R represents a tristyrylphenyl group (“Simsol” TS 26 “Seppic”) (15.7 g) is added over 10 minutes. Then, a diisocyanate compound (a1) (IPDI) (9.8 g) is introduced using a syringe and under stirring at 150 rpm. The reaction is continued at 100° C. for 1 hour.

The isocyanate level is then checked by back-assay to ensure that it is zero. The resulting copolymer P5 is formulated with an ethoxylated alcohol-type surfactant compound (“Simulsol” Ox1008 “Seppic”) (118 g), 1,000 ppm of a biocide (“Biopol” SMV “Chemipol”), 1,000 ppm of an anti-foaming agent (“Tego” 1488 “Evonik”) and water (700 g). This results in an aqueous rheology control composition R5 according to the invention made of 18% by mass of copolymer P5 according to the invention, of 12% by mass of surfactant compound and of 70% by mass of water.

### Preparation and Characterisation of Aqueous Anode Compositions T1 to T4 According to the Invention

47 g of water and 2.06 g of a polyacrylic acid dispersing agent (molecular mass 600,000 g/mol measured by SEC) are introduced into a 500-mL polypropylene container suitable for a stirrer (“Speedmixer” DAC 1100), then mixed for 1 minute at 800 rpm. 50 g of material E (natural graphite powder D50 17-19 μm—“MSE Supply”) are added and the mixture is mixed for 1 minute and 30 seconds at 1,600 rpm. The pH is adjusted to a pH of 6 using a 95% by weight dry aqueous solution of AMP (2-amino-2-methyl-1-propanol). Stir for 1 minute at 1,600 rpm.

2.08 g of rheological agent R1 are added and mixed for 1 minute at 1,600 rpm. 1.56 g of binding agent L1 (styrene-butadiene latex-BM 451B “Zeon”) is added and the mixture is mixed for 1 minute at 800 rpm. This results in the anode composition T1 according to the invention.

Similarly, the aqueous anode compositions T2, T3 and T4 are prepared by replacing the rheological agent R1 with the rheological agents R2 (3.85 g), R3 (2.08 g) and R4 (3.85 g), respectively, and using an amount of water of 46 g, 47 g and 46 g for the compositions T2, T3 and T4, respectively.

Using a rheometer (“Haake Mars III”), their rheological profiles are determined by measuring their viscosity (mPa·s) at 25° C. and different shear rates using a plane-cone spindle (CP60) under imposed stress.

Their viscoelastic structure is also assessed by measuring the variation in the dephasing angle δ) (°, obtained using the ratio of the loss modulus G″ to the elastic modulus G′ (tan δ=G″/G′), relative to the variation in shear stress. The elastic modulus G′ and loss modulus G″ are quantified using viscoelasticity measurements at 1 Hz with a rheometer (“Haake Mars III”) equipped with a plane-cone spindle (CP35) under imposed stress (Pa). Their thixotropic behaviour is also determined by assessing application efficacy using 3-phase thixotropy tests (3-ITT) stimulating the behaviour of the anode composition at rest, during application and during post-application restructuring. These viscosity measurements (mPa·s) were taken at 25° C., in 3 phases, using a plane-cone spindle (CP35):
pre-shear at 100 s⁻¹ for 10 seconds for 5 points;
60-second shear-free rest for 5 points;
measurement at a low shear rate of 0.1 s⁻¹ to determine the viscosity of the composition at rest, with a 180-second measurement for 20 points;
measurement at a shear rate of 1,000 s⁻¹ to determine the viscosity of the composition during application, with a 30-second measurement for 20 points;
measurement at a low shear rate of 0.1 s⁻¹ to reveal the speed at which the sample restructures, with a 200-second measurement for 150 points;
measurement at a low shear rate of 0.1 s⁻¹ to reveal the behaviour of the structure over a long acquisition time, with a 400-second measurement for 50 points.

The results are shown in Tables 1, 2 and 3, respectively

TABLE 1

| | Viscosity (mPa · s) at | | | | | |
|---|---|---|---|---|---|---|
| Composition | 0.01 s⁻¹ | 0.1 s⁻¹ | 1 s⁻¹ | 30 s⁻¹ | 120 s⁻¹ | 1,000 s⁻¹ |
| T1 | 19.8 | 15.2 | 9.9 | 2.6 | 0.92 | 0.23 |
| T2 | 11.2 | 8.6 | 6.6 | 2.5 | 1.3 | 0.29 |
| T3 | 13.7 | 8.3 | 2.8 | 0.83 | 0.52 | 0.22 |
| T4 | 6.4 | 4.5 | 3.8 | 2.1 | 1.1 | 0.30 |

TABLE 2

Dephasing angle (°) at

| Composition | 0.01 Pa | 0.1 Pa | 1 Pa | 10 Pa | 100 Pa |
|---|---|---|---|---|---|
| T1 | 57.8 | 56.8 | 61.9 | 72.5 | 84.3 |
| T2 | 76.0 | 74.0 | 80.7 | 83.5 | 82.6 |
| T3 | 68.8 | 68.9 | 81.4 | 81.2 | 88.2 |
| T4 | 72.8 | 70.7 | 77.4 | 78.6 | 85.0 |

TABLE 3

| | Viscosity (mPa · s) at | | | | | |
|---|---|---|---|---|---|---|
| | 100 s | 250 s | 270 s | 285 s | 500 s | 800 s |
| | measured under shear of | | | | | |
| Composition | 0.1 s⁻¹ | 0.1 s⁻¹ | 1,000 s⁻ | 0.1 s⁻¹ | 0.1 s⁻¹ | 0.1 s⁻¹ |
| T1 | 22.5 | 24.3 | 0.28 | 16.0 | 21.7 | 22.3 |
| T2 | 9.1 | 11.7 | 0.32 | 6.7 | 16.4 | 17.3 |
| T3 | 4.9 | 7.9 | 0.23 | 1.9 | 7.7 | 12.6 |
| T4 | 5.7 | 8.1 | 0.32 | 4.5 | 11.4 | 15.9 |

### Preparation and Characterisation of an Anode According to the Invention

A 12-μm-thick copper foil is coated with a 200-μm wet coat of aqueous anode composition T1 according to the invention using a 4-hole manual applicator on a vacuum application table at a speed of 10 mm/s. The coated foil is then dried for 24 hours in a climate-controlled chamber at a temperature of 25° C. and a humidity of 50%. Once dry, the coated foil is calendered on both sides at a pressure of 25 kg/cm² and a speed of 0.1 m/s using a calender machine (“Gester”). Discs with a diameter of 12 mm are cut out using a precision cutter.

Similarly, anodes are prepared using the aqueous anode compositions T2, T3 and T4 by replacing the composition T1 with one of these compositions according to the invention.

Immediately after preparation, the uniformity and adhesion of the composition coat are assessed by visual inspection of the prepared anodes: no aggregates or surface heterogeneities are visible on the surface of the coat when viewed from the front in daylight. The coat has no adhesion flaws.

The aqueous anode composition T according to the invention comprising the rheological agent R has a thixotropic behaviour that allows for easy and effective application when preparing an anode. The aqueous anode composition according to the invention makes it possible to prepare an anode with a regular, uniform and stable active surface.

1. An aqueous anode composition T, comprising:
at least one rheological agent R comprising at least one water-soluble, non-ionic urethane polymer P prepared by polymerisation reaction:
a) of at least one isocyanate compound (a) independently chosen among a diisocyanate compound (a1), a polyisocyanate compound (a2) and combinations thereof;
b) of at least one compound (b) of formula I: 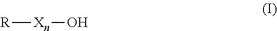
wherein:
R independently represents a group chosen among a straight C₄-C₄₀-alkyl group, a branched C₄-C₄₀-alkyl group, a C₅-C₄₀-cycloalkyl group, a straight C₄-C₄₀-alkenyl group, a branched C₄-C₄₀-alkenyl group, a C₅-C₄₀-cycloalkenyl group, a C₅-C₄₀-aryl group and combinations thereof,
X independently represents an alkoxylated group chosen among oxyethylene, oxypropylene, oxybutylene and combinations thereof,
n represents 0 or a number ranging from 1 to 500; and
c) of at least one polyhydroxylated and polyalkoxylated compound (c);
at least one material E chosen among metal fibres, metal particles, carbon graphite fibres, carbon graphite particles, silicon particles and combinations thereof; and
at least one binding agent L of the material E chosen among a polymer L1 in the form of a water-insoluble latex, a water-soluble polymer L2 and combinations thereof.

2. The composition T according to claim 1 in which:
the diisocyanate compound (a1) is chosen among:
a symmetric aromatic diisocyanate compound;
a symmetric alicyclic diisocyanate compound;
a symmetric aliphatic diisocyanate compound;
a asymmetric aromatic diisocyanate compound;
a asymmetric alicyclic diisocyanate compound; or
the polyisocyanate compound (a2) strictly comprises more than 2 isocyanate groups; or
the polyisocyanate compound (a2) is chosen among:
triphenylmethane-4,4′,4″-triisocyanate or 1,1′,1″-methylidynetris (4-isocyanatobenzene);
an isocyanurate compound chosen among:
a symmetric aromatic diisocyanate compound;
a symmetric alicyclic diisocyanate compound;
a symmetric aliphatic diisocyanate compound; and
a asymmetric aromatic diisocyanate;
a biuret trimer compound chosen among:
a symmetric aromatic diisocyanate compound;
a symmetric alicyclic diisocyanate compound;
a symmetric aliphatic diisocyanate compound;
a asymmetric aromatic diisocyanate compound; and
a asymmetric alicyclic diisocyanate compound.

3. The composition T according to claim 1 in which the compound (b) is a compound of formula I wherein:
R independently represents a group chosen among a straight C₆-C₃₂-alkyl group, a branched C₆C₃₂-alkyl group, a C₆-C₃₂-cycloalkyl group, a straight C₆-C₃₂-alkenyl group, a branched C₆-C₃₂-alkenyl group, a
C₆-C₃₂-cycloalkenyl group, a C₆-C₃₆-aryl group and combinations thereof; or
X independently represents an alkoxylated group chosen among an ethoxylated group, a propoxylated group, a butoxylated group and combinations thereof; or
n represents 0 or a number ranging from 1 to 300.

4. The composition T according to claim 1 in which the compound (c) is chosen among:
a compound (c1) of formula II: 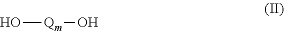
wherein:
Q independently represents an oxyalkylene residue;
m independently represents a number ranging from 30 to 1,000;
a compound (c1) of formula II combined with a non-alkoxylated compound (c2) comprising at least three hydroxyl groups;
a polyalkoxylated compound (c3) comprising at least three hydroxyl groups; and
combinations thereof.

5. The composition T according to claim 1 in which the compound (c) is chosen among:
a compound (c1) of formula II: 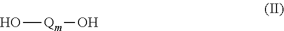
wherein:
Q independently represents an oxyethylene residue; or
m independently represents a number ranging from 50 to 600;
or wherein Q independently represents an oxyethylene residue and m independently represents a number ranging from 50 to 600;
a compound (c2) comprising three hydroxyl groups; and
a polyalkoxylated compound (c3) different from compound (c2) and comprising three hydroxyl groups.

6. The composition T according to claim 1 in which:
the compound (c) comprises from 10 to 500 alkoxylations, or
the compound (c) is polyethoxylated or is polyethoxylated-polypropoxylated or is polyethoxylated-polybutoxylated;
or in which:
the compound (c), (c1) or (c3) independently has a molecular mass by weight (Mw) measured by SEC ranging from 1,500 g/mol to 40,000 g/mol.

7. The composition T according to claim 1, in which the polymerisation reaction uses:
from 20 mol % to 74.9 mol % of compound (a), or
from 25 mol % to 79.9 mol % of compound (b), or
from 0.1 mol % to 55 mol % of compound (c), relative to the total molar amount of compounds (a), (b) and (c).

8. The composition T according to claim 1 in which the polymerisation reaction also uses at least one additional cross-linking compound (d).

9. The composition T according to claim 1 in which:
the material E is chosen among silicon, carbon graphite or graphitic carbon, hexagonal carbon, rhombohedral carbon and combinations thereof, optionally doped with at least one element; or
the material E is in the form of particles.

10. The composition T according to claim 1, in which:
the polymer L1 is chosen among a styrene-butadiene rubber (SBR) polymer, phenyl-propane latex, ethylene/ethylene-acetate (EVA) copolymer, acrylic latex, methacrylic latex, acrylonitrile latex, polymethyl-methacrylate, water-insoluble ASE polymer latex, water-insoluble HASE polymer latex and combinations thereof; or
the water-soluble polymer L2 is independently chosen among a water-soluble ASE polymer, a water-soluble HASE polymer, a water-soluble acrylic polymer, polyvinyl alcohol (PVA), poly(ethylene oxide) (PEO), carboxymethyl cellulose (CMC), sodium polyacrylate, modified polyacrylic acid, acrylamide homopolymer, acrylamide copolymer and combinations thereof.

11. The composition T according to claim 1, in which:
the polymer L1 is a styrene-butadiene polymer, or
the water-soluble polymer L2 is an acrylic latex, or
the water-soluble polymer L2 is prepared in the presence of at least one initiator compound, by a polymerisation reaction of at least one anionic monomer M1 chosen among acrylic acid, methacrylic acid, an acrylic acid oligomer, an acrylic acid salt, a methacrylic acid salt and combinations thereof, and optionally of at least one monomer different from the monomer M1 and independently chosen among:
an anionic monomer M2, different from the anionic monomer M1, is chosen among maleic acid, a maleic acid salt, itaconic acid, an itaconic acid salt, crotonic acid, a crotonic acid salt and combinations thereof,
an organosulphur monomer M3,
a non-ionic monomer M4 chosen among vinyl acetate, a C₁-C₈ ester from a compound derived from an acid chosen among acrylic acid, methacrylic acid, maleic acid, itaconic acid and crotonic acid (for example ethyl methacrylate, methyl methacrylate, butyl methacrylate, ethyl acrylate, methyl acrylate, butyl acrylate), hydroxyethyl methacrylate, hydroxyethyl acrylate, hydroxypropyl methacrylate, hydroxypropyl acrylate, a nitrogen-containing monomer (for example acrylonitrile, methacrylamide, acrylamide, vinyl lactam, N-methylol acrylamide), styrene and combinations thereof,
a cross-linking monomer M5, and
combinations thereof or
the polymer L2 is prepared using:
from 2% by weight to 100% by weight of at least one monomer M1, and
from 0 to 98% by weight of at least one other monomer, different from monomer M1, or
the water-soluble polymer L2 has a weight-average molecular mass Mw (measured by SEC) of less than 1,000,000 g/mol, or
the water-soluble polymer L2 has a weight-average molecular mass Mw (measured by SEC) greater than 2,000 g/mol or greater than 5,000 g/mol.

12. The composition T according to claim 1 comprising no other binding compound other than the binding agent L or also comprising:
at least one other binding compound, different from binding agent L, or
at least one organic acid or one mineral acid; or also comprising:
at least one other compound chosen among a (meth)acrylic comb polymer, polyethylene, a fluorinated binding compound, for example a compound chosen among polyvinylidene fluoride (PVDF), poly(vinyl-pyrrolidone), polytetrafluoroethylene (PTFE), chlorotrifluoroethylene (ECTFE), polyethylene tetrafluoroethylene (ETFE), fluorinated ethylene propylene (FEP), perfluoroalkoxy (PFA), polychlorotrifluoroethylene (PCTFE), fluoracrylates, fluorosilicones and combinations thereof.

13. The composition T according to claim 1 further comprising at least one dispersing agent of material E, and at least one other monomer and combinations thereof.

14. The composition T according to claim 1 comprising:
from 0.2% by dry weight to 5% by dry weight of rheological agent R,
from 85% by dry weight to 99.5% by dry weight of material E and
from 0.3% by dry weight to 10% by dry weight of binding agent,
relative to the total amount by dry weight of rheological agent R, of binding agent, and of material E.

15. The composition T according to claim 1 in which:
a viscosity, measured at 25° C. and at 0.01 s⁻¹ according to the method in the description, is greater than 2 mPa·s; or
the viscosity, measured at 25° C. and at 1,000 s⁻¹ according to the method in the description, is greater than 0.1 mPa·s; or
a dephasing angle at 1 Hz, measured at 25° C. and at 0.01 Pa according to the method in the description, is greater than 30°, or
the dephasing angle at 1 Hz, measured at 25° C. and 100 Pa according to the method in the description, is greater than 60°.

16. The composition T according to claim 1 in which the polymer P has a molar mass (Mw) measured by SEC ranging from 4,000 g/mol to 150,000 g/mol.

17. A method for preparing an aqueous composition T according to claim 1, comprising:
preparing a binding agent L,
preparing a rheological agent R,
adding at least one material E chosen among metal fibres, metal particles, carbon graphite fibres, carbon graphite particles and combinations thereof, optionally doped with at least one element.

18. A method for producing an anode comprising:
applying at least one composition T according to claim 1 to a substrate; and
drying and then calendering the coated substrate.

19. The method for producing an anode according to claim 18, wherein:
the applying is carried out at a pH of less than 7 or at a pH ranging from 4 to 6.5, or
the composition T is applied to the substrate at a thickness, after drying and calendering, measured using a 1 μm to 1,000 μm coating thickness gauge, that is less than 500 μm, or
the composition T is applied to the substrate at a thickness, after drying and calendering, measured using a 1 μm to 1,000 μm coating thickness gauge, that is greater than 5 μm, or in which:
the composition T is uniformly applied to the substrate according to the method in the description.

20. An anode produced according to the manufacturing method of claim 18.
